(19) United States
(12) Patent Application Publication
(10) Pub. No.: US 2003/0042114 A1
(43) Pub. Date: Mar. 6, 2003

(54) Conveyance system

(75) Inventor: Yukio Iizuka, Gamo-gun (JP)

Correspondence Address: D. Peter Hochberg Co., L.P.A., The Baker Building - 6th Floor, 1940 East 6th Street, Cleveland, OH, 44114-2294, US

(73) Assignee: Daifuku Co., Ltd.

(21) Appl. No.: 10/228,790

(22) Filed: Aug. 27, 2002

(30) Foreign Application Priority Data
Aug. 31, 2001 (JP) 2001-262583

(51) Int. Cl. B65G 37/00

(52) U.S. Cl. 198/570

(57) ABSTRACT

In a conveyance system comprising a movable body supported and guided by a rail device and movable in a fixed path, a feeder line laid along the fixed path, a power receiving means opposed to the feeder line and installed in the movable body, thereby effecting the feeding of power to the movable body by a noncontact power feeding system, main path feeder lines and branching feeder lines are installed overlapping each other on both sides in a branching/joining portion or the like, with the result that the entire arrangement becomes complicated and expensive. In the main path portion of a fixed path, a feeder line is laid along the main path portion, a power receiving means opposed to the feeder line is installed in the movable body to effect the feeding of power to the movable body by a noncontact power feeding system, while in an auxiliary path portion having no feeder line, the feeding of power is effected by a power storing means mounted on the movable body. Thus, the feeding of power is effected by either one of the main and auxiliary path portions, the power receiving means is required only in a single place, the overall arrangement can be made simply and at low cost, and a requirement for an additional installation or the like can be easily coped with.

### FIELD OF THE INVENTION

The present invention relates to a conveyance system utilized to support and convey various things.

### BACKGROUND OF THE INVENTION

As for conveyance systems of this type, there has been provided an arrangement shown, for example, in Japanese Patent Unexamined Publication No. 10-111719. This conventional arrangement includes a conveying cart supported and guided by a main track and a branch track, each track comprising a bottom wall, right and left side walls, and an upper wall, with a longitudinally extending slit formed in the widthwise middle region of the upper wall. And, feeder lines are installed on the side walls of the main and branch track, and branch point feeder line installed in the branch point is connected to the branch track feeder line. Further, the conveying cart is provided with pickup coils on the right and left sides. According to such prior arrangement, it is possible to run the conveying cart on the main track with the right-hand side pickup coil receiving electric energy in a noncontact manner from the main track feeder line. Further, it is possible to run the conveying cart on the branch track with the left-hand side pickup coil receiving electric energy in a noncontact manner from the branch point feeder line and branch track feeder line.

However, according to the prior art arrangement described above, since the main tack feeder lines and branch point feeder lines are installed overlapping each other on both sides, the entire arrangement becomes complicated and expensive. Further, the conveying cart is provided on the right and left sides thereof with pickup coils, and this also makes the entire arrangement complicated and expensive. In addition, the above problems can be solved by mounting a battery on the conveying cart to feed electricity to the conveying cart to run it on the main track and branch track. In this case, however, a large-sized battery has to be mounted, increasing the size and weight of the conveying cart, and requiring a substantial amount of charging time.

### DISCLOSURE OF THE INVENTION

Accordingly, an object of the invention is to provide a conveyance system capable of making the entire arrangement simple and less expensive and smoothly effecting the overall movement including branching and joining.

To achieve the above object, a conveyance system according to the invention comprises a rail device, and a movable body supported and guided by the rail device to move in a fixed path, and is characterized in that a main path portion of the fixed path includes a feeder line laid along the main path portion, and a power receiving means opposed to the feeder line is installed in the movable body, whereby the feeding of power to the movable body is effected by a noncontact power feeding system, while in an auxiliary path portion having no feeder line laid therealong in the fixed path, the feeding of power is effected by a power storing means mounted on the movable body.

According to the above arrangement of the invention, the feeding of power to the various devices of the movable body, that is the feeding of power to the main feeder line, can be effected by a noncontact power feeding system in which the power receiving means opposed to the feeder line is moved with the movable body. In the auxiliary path portion, no feeder line is laid and the feeding of power by the noncontact power feeding system is cut off, but the feeding of power in this case can be effected by the power storing means. Thereby, the overall movement including branching and joining can always be smoothly effected.

Thus, the feeding of power is effected either by the main path portion or the auxiliary path portion, and the power receiving means is required to be provided only at a single place, so that the overall arrangement can be made simply and at a lower cost, and the requirement for an additional installation or the like can be easily coped with. And the power storing means may be a small-sized one since it is used for movement over a limited short distance and hence its maximum power consumption is low. Thus, the movable body can be constructed to be small in size and light in weight.

A first preferred embodiment of the conveyance system of the invention is characterized in that an auxiliary path portion is a path portion which branches off or join the main path portion.

According to this first embodiment, the branching movement from the main path portion to the auxiliary path portion, and joining movement from the auxiliary path portion to the main path portion can always be smoothly effected.

A second preferred embodiment of the conveyance system of the invention is characterized in that when the feed of power by the noncontact power feeding system becomes insufficient during movement in the main path portion, the insufficiency is compensated for by the feeding of power from the power storing means.

According to this second embodiment, when the feeding of power by the noncontact power feeding system becomes insufficient during movement of the movable body in the main path portion, for example, during acceleration or deceleration, the insufficiency can be automatically compensated by the feeding of power from the power storing means. Thus, the intended acceleration or deceleration can be smoothly and suitably effected.

A third preferred embodiment of the conveyance system of the invention is characterized in that the power storing means is charged by the surplus from the feeding of power by the noncontact power feeding system during movement in the main path portion.

According to this third embodiment, when the movable body is stably moved in the main path portion, the feeding of power by the noncontact power feeding system provides an excess of power, when the power storing means can be automatically charged by this excess of power. Therefore, without purposely providing a battery charging time, the power storing means can be maintained fully charged at all times.

### BRIEF DESCRIPTION OF THE DRAWINGS

FIG. 1 is a perspective view of a branching/joining portion in a conveyance system according to a first embodiment of the invention,;

FIG. 2 is a front view, partly broken away, of the conveyance system;

FIG. 3 is a side view, partly broken away, of an essential part of the conveyance system;

FIG. 4 is a plan view of the essential part of the conveyance system;

FIG. 5 is a perspective view of an essential part of a movable body in the conveyance system;

FIG. 6 is a plan view of a branching/joining place in the conveyance system, wherein (a) shows a view taken before branching and (b) shows a view taken during branching;

FIG. 7 is a plan view of a branching/joining place in the conveyance system, wherein (a) shows a view taken during branching/joining and (b) shows a view taken during joining;

FIG. 8 illustrates a circuit of a power feeding portion in the conveyance system;

FIG. 9 is a schematic plan view in the conveyance system according to a second embodiment of the invention;

FIG. 10 is a schematic perspective view in the conveyance system according to a third embodiment of the invention;

FIG. 11 is a schematic plan view in the conveyance system according to a fourth embodiment of the invention;

FIG. 12 is a schematic plan view in the conveyance system according to a fifth embodiment of the invention;

FIG. 13 is a schematic plan view in the conveyance system according to a sixth embodiment of the invention;

FIG. 14 is a schematic plan view in the conveyance system according to a seventh embodiment of the invention; and

FIG. 15 is a schematic plan view in the conveyance system according to an eighth embodiment of the invention.

### EMBODIMENTS

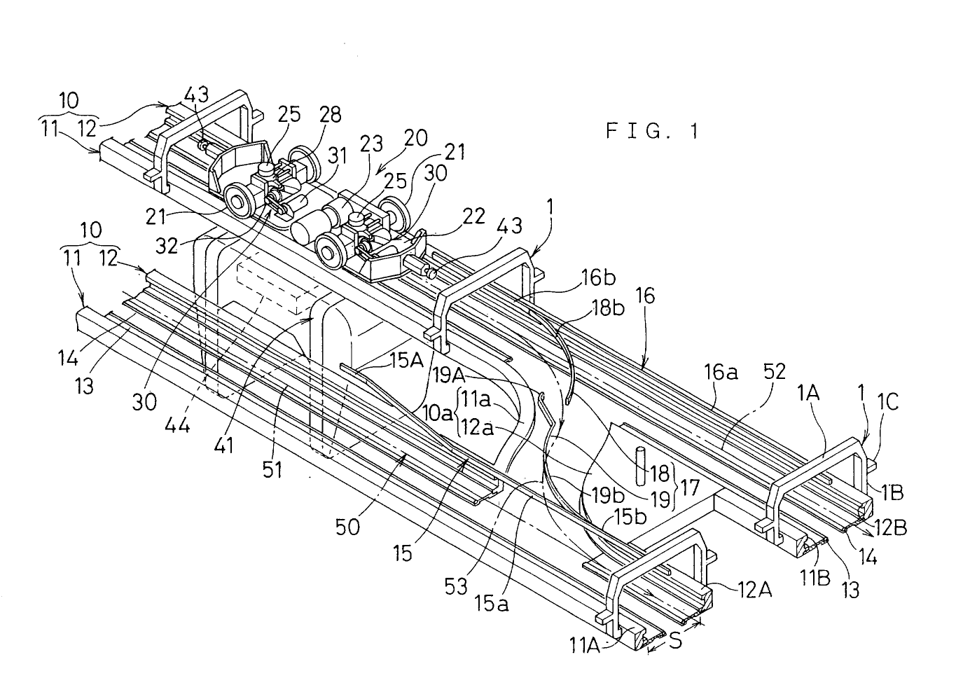

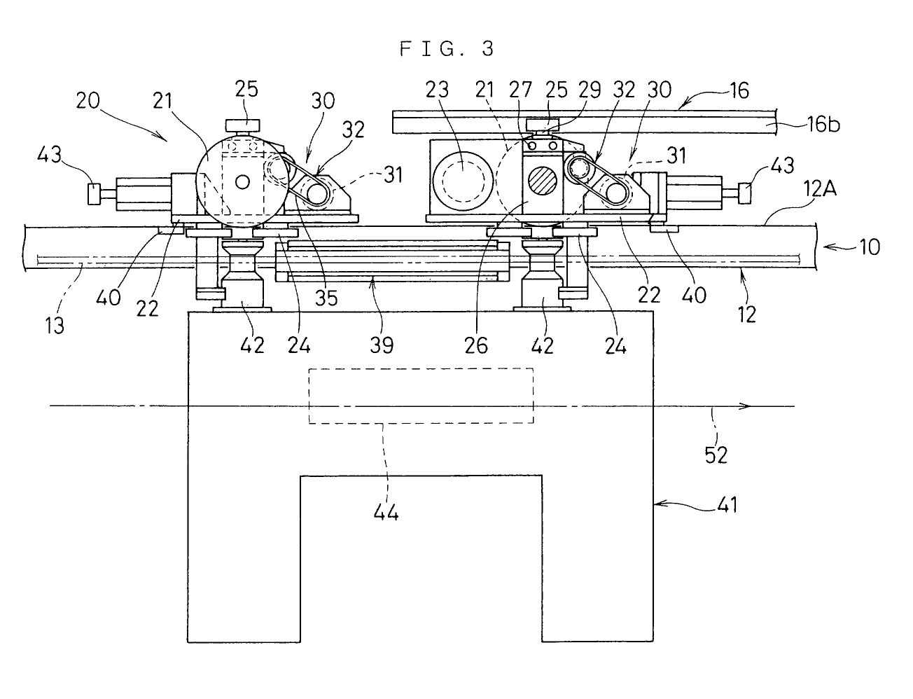

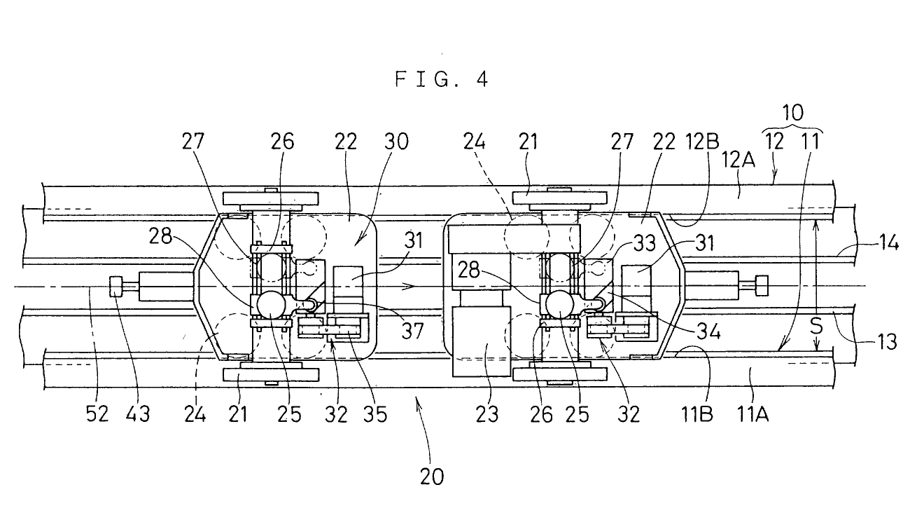

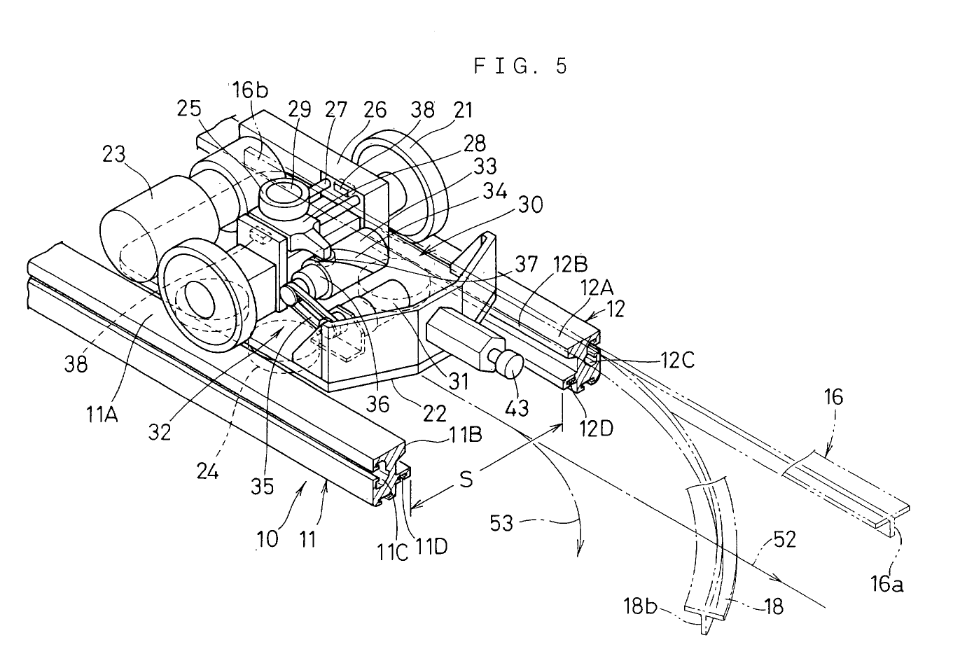

A first embodiment of the invention will now be described with reference to FIGS. 1 through 8.

In FIGS. 1 through 5, a rail device 10 comprises a pair of right and left rail bodies 11 and 12, which are in the form of shape steel, arranged in line symmetry. And both rail bodies 11 and 12 are formed, at their upper surfaces, with upwardly directed wheel support surfaces 11A and 12B, respectively, and formed, at their upper inwardly directed surfaces, with inwardly directed roller guide surfaces 11B and 12B. Further, both rail bodies 11 and 12 are respectively formed with outwardly directed, sideway dovetail grooves 11C and 12C and downwardly directed downward dovetail grooves 11D and 12D.

Both rail bodies 11 and 12 are supported by a ceiling beam 2 through a plurality of rail yokes 1 spaced at predetermined intervals. That is, each rail yoke 1 comprises an upper plate portion 1A, side plate portions 1B depending from adjacent both ends of the upper plate portion 1A, and connecting portions 1C projecting outward from the intermediate regions of the outer surfaces of the side plate portions 1B, and is integrally formed in a gate shape in-a front view.

The rail yoke 1 is supported through fasteners (bolts, nuts, etc.) 3 acted on by both connecting portions 1C, in such a manner that its height and attitude are adjustable with respect to the ceiling beam 2. And the outer surfaces of both rail bodies 11 and 12 are pressed against the lower inner surfaces of the side plate portions 1B and connected through fasteners 4 utilizing the sideway dovetail grooves 11C and 12C. Thereby, both rail bodies 11 and 12 are arranged with a predetermined clearance S defined therebetween.

A fixed path 50 is defined by the rail device 10 comprising the pair of right and left rail bodies 11 and 12. In this case, the fixed path 50 is defined, for example, by a pair of side-by-side linear path portions (an example of the main path portion) 51 and 52, and a branching/joining path portion (an example of an auxiliary path portion) 53 disposed between these linear portions 51 and 52. In this branching/joining path portion 53, the respective rail bodies on one side are continuously formed by the rail bodies 11 and 12 of the branching/joining path portion 53 in the pairs of right and left rail bodies 11 and 12.

That is, in the branching/joining path portion 53 also, a pair of right and left rail bodies 11a and 12a of the same sectional shape as that of the rail bodies 11 and 12 are arranged, and these rail bodies 11a and. 12a constitute the rail device 10a of these, the rail body 11a on the branching path side is formed in such a manner that after it is curved toward the linear path portion 51 in the branching/joining path portion 53 from the portion forming the linear path portion 52, it connects to the cut end of the rail body 12 forming the linear path portion 51.

Further, the other rail body 12a is formed to extend along the rail body 11a and in this case, it is formed in such a manner that after it is curved toward the linear path portion 52 in the branching/joining path portion 53 from the portion forming the linear path portion 51, it connects to the cut end of the rail body 11 forming the linear path portion 52.

The branching/joining place defined by the path portions 51-53 is provided with linear guide bodies 15 and 16 extending along the linear path portions 51 and 52, and a branching/joining guide body 17 extending along the branching/joining path portion 53. In this case, the guide bodies 15, 16 and 17 are disposed between and above the pairs of right and left rail bodies 11, 12 and 11a, 12a, and connected to the lower surface of the upper plate portion 1A in the rail yoke 1. The linear guide bodies 15 and 16 are formed with linear guide portions 15a and 16a on the outer side with respect to the parallel side, and branching/joining guide portions 15b and 16b on the inner side.

Further, the branching/joining guide body 17 is composed of a branching guide member 18 and a joining guide portion 19 which are severed, and a branching guide portion 18b and a joining guide portion 19b which connect to the branching/joining guide portions 15b and 16b are formed to face in opposite directions. Further, the severed portion is so formed that a direction control member (to be later described) which has come moving on the branching guide portion 18b is guided to the joining guide portion 19b, since the free end of the joining guide member 19 is formed as a pickup portion 19A projecting upward.

In addition, the linear guide body 15 extending along the linear path portion 51, too, has its initial end portion formed as a pickup portion 15A projecting toward the joining/branching side so that the direction control member that has moved in is guided to the linear guide portion 15a.

There is installed a self-propelled body (an example of a movable body) 20 supported and guided by the rail device 10 to move in the fixed path 50. This self-propelled body 20 is composed of a pair of front and rear trolley main bodies 22 having rollable wheels 21 supported and guided by the wheel support surfaces 11A and 12A, a transport subject holding device 41 disposed between the lower ends of both trolley main bodies 22, a travel drive unit (motor) 23 operatively connected to one wheel 21, and the like.

And both trolley main bodies 22 in the self-propelled body 20 are freely rotatably provided with a pair of front and rear side guide rollers 24 guided by the roller guide surfaces 11B and 12B. Further, both trolley main bodies 22 are provided with a direction control roller (an example of a direction control member) 25 guided by the sideway guide portions 15a, 15b, 16a, 16b, 18b, and 19b of the guide bodies 15-17. In this case, the direction control roller 25 is transversely movable by a left-right movement means 30 between a position opposed to the linear guide bodies 15 and 16 and a position opposed to the branching/joining guide body 17.

That is, a pair of right and left brackets 26 are provided in the upper region of the trolley main body 22, and transverse guide rods 27 are provided in a pair, front and rear, between these brackets 26. And, a support body 28-is provide which is supported and guided by the guide rod 27 and is transversely movable, and the upper surface of this support body 28 is provided with the direction control roller 25 freely rotatable through a vertical pin 29.

The left-right movement means 30 has a reversible drive section (drive motor) 31, which is disposed on the upper portion of the trolley main body 22 with its drive shaft directed transversely. And provided on the upper portion of the trolley main body 22 is a drive transmission section 32 for transversely moving the support body 28 by the forward/backward driving of the drive section 31.

This drive transmission section 32 comprises a cam roller 33 rotatable around the transverse axis, a spiral groove 34 formed in the outer peripheral surface of the cam roller 33, a wrapping transmission mechanism (such as of a timing belt type or chain type) for operatively connecting the drive shaft of the drive section 31 to the cam roller 33. In this case, the drive transmission section 32 is provided with a clutch (an example of a closing-opening means) 36 and the like for closing/opening the transmission path.

A cam follower 37 installed in the support body 28 is fitted in the spiral groove 34. In addition, the whole of the support body 28 or the right and left ends thereof are made of magnetic material. Magnet bodies (an example of an attraction means) 38 for attractively holding the support body 28 reaching the right- and left-hand side movement limit positions are embedded in both brackets 26 at positions where the support body 28 can abut thereagainst.

According to the left-right movement means 30 arranged as described above, the cam roller 33 is rotated forwardly and backwardly by the forward and backward driving of the drive section 31 through the wrapping transmission mechanism 35, and the support body 28 is supported and guided by the guide rod 27 and transversely moved through the cam follower 37 fitted in the rotating spiral groove 34. Thus, the direction control roller 25 is transversely moved through the support body 28.

Thereby, the direction control roller 25 is transversely movable between the position opposed to the linear guide bodies 15 and 16 and the position opposed to the branching/joining guide body 17. And the support body 28 reaching the right- and left-hand side movement limit positions is held in the right- and left-hand side movement limit positions by the attracting action of the magnet bodies 38. Further, since the clutch 36 is disengaged, the cam roller 33 becomes freely rotatably.

It is arranged that in the linear path portions 51 and 52 in the fixed path 50, the feeding of power to the self-propelled body 20 is effected by a noncontact power feeding system. That is, feeder lines (cord lines) 13 and 14 are laid in the rail bodies 11 and 12 to extend along the linear path portions 51 and 52 (along the direction of the rail length) by utilizing the downward dovetail groove 11D, and pickup coils (an example of a power receiving means) 39 opposed to the feeder-lines 13 and 14 are installed between the trolley main bodies 22 of the self-propelled body 20. Further, the trolley main body 22 is provided with a detector 40, and a body to be detected (not shown) for travel control is installed at a predetermined place in the fixed path 50.

The holding device 41 is suspended between the trolley bodies 22 of the self-propelled body 20. This holding device 41 is in the form of a box which is opening the right and left and lower sides, with the upper surface connected to the trolley main bodies 22 through connectors 42. And a transverse transfer mount means (not shown) and the like are disposed in the holding device 41. In addition, both trolley main bodies 22 are provided with stopper bodies 43 projecting outward (forward and rearward).

The self-propelled body 20 side, that is the portion of the holding device 41, has a battery (an example of a power storing means) 44 mounted thereon. Therefore, in the branching/joining path portion 53 of the fixed path 50 where no feeder lines 13 and 14 are laid, the feeding of power is effected by this battery 44.

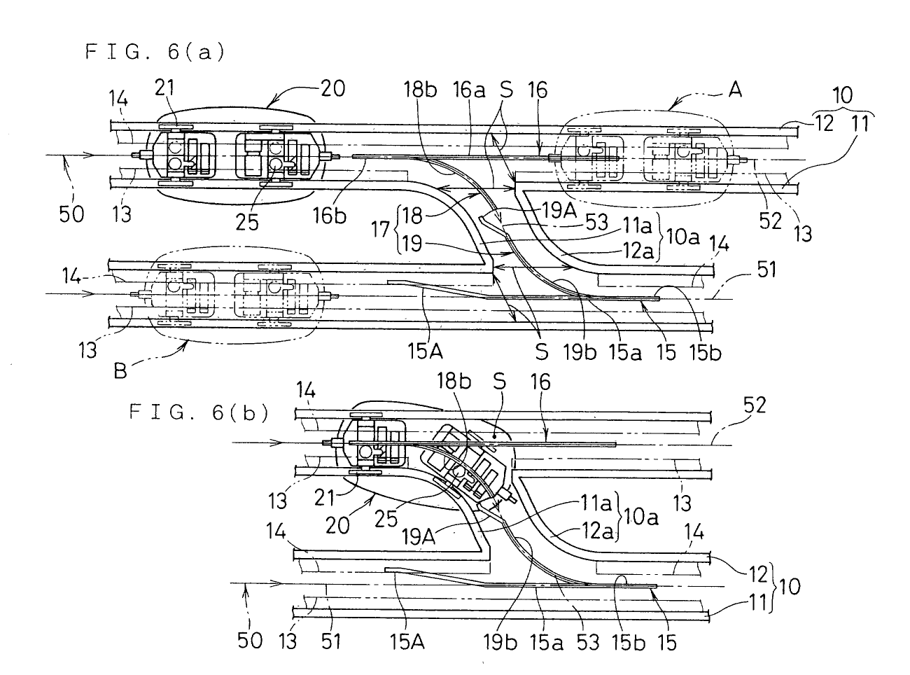

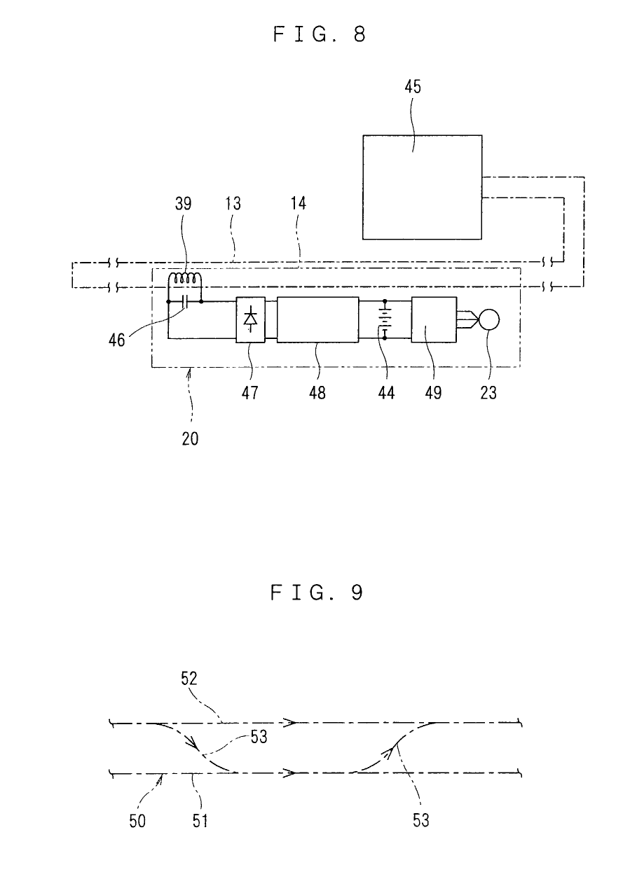

In FIG. 8, both feeder lines 13 and 14 are connected to the power source device 45 in an endless manner. That is, in FIGS. 1 and 6, in the branching/joining portion with respect to the branching/joining path portion 53, the feeder lines 13 and 14 are shown as severed. However, in reality, they are connected by a bypass line (not shown), not severed. In FIG. 8, the wiring circuit extending from the pickup coil 39 to a travel drive device 23 has a resonance capacitor 46, a rectifier 47, a DC/DC converter 48, the battery 44, a controller 49 and the like incorporated therein.

Such wiring circuit ensures that when the feeding of power by the noncontact power feeding system becomes insufficient when the self-propelled body 20 is traveling in the linear path portions 51 and 52, the insufficiency is compensated by the feeding of power from the battery 44. Further, it is arranged that when the self-propelled body 20 is traveling in the linear path portions 51 and-52, the battery 44 is charged by the excess of power from the feeding of power by the noncontact power feeding system.

The operation of the first embodiment described above will now be described.

The travel of the self-propelled body 20 in the fixed path 50 is effected as guided by the rail devices 10 and 10a in that the wheels 21 supported and guided by the wheel support surfaces 11A and 12A are rolled and in that the side guide rollers 24 are guided by the roller guide surfaces 11B and 12B. In this case, in the linear path portions 51 and 52, the feeding of power to the self-propelled body 20 is effected by the noncontact power feeding system through the pickup coils 39 opposed to the feeder lines 13 and 14, or the like.

During travel in this state, the self-propelled body 20 traveling in the linear path portion 52 on one side, as shown by solid line in FIG. 6(a), for example, detects the detection subject by the detector 40 shortly before the self-propelled body 20 reaches the branching/joining place to decide whether to go straight on or to branch thereoff, and moves the direction control roller 25 toward the advance (travel) side.

That is, the drive section 31 is driven forward/backward according to the indication signal based on the decision, and since the clutch 36 has been engaged, the cam roller 33 is rotated forward/backward through the wrapping transmission mechanism 35. Thereupon, the support body 28 supported and guided by the guide rod 27 is transversely moved through the cam follower 37 fitted in the rotating spiral groove 34, thus, the direction control roller 25 is moved right and left through the support body 28.

Thereby, the direction control roller 25 is transversely moved between a position opposed to the linear guide body 16 and a position opposed to the branching/joining guide body 17. And the support body 28 reaching the right- and left-hand side movement limit positions is held in the right- and left-hand side positions by the attracting action of the magnet bodies 38, when the clutch 36 is disengaged. In addition, in giving an instruction signal based on the decision, if the direction control roller 25 has already been moved toward the advance side, this instruction signal is canceled, so that the drive section 31 is not driven.

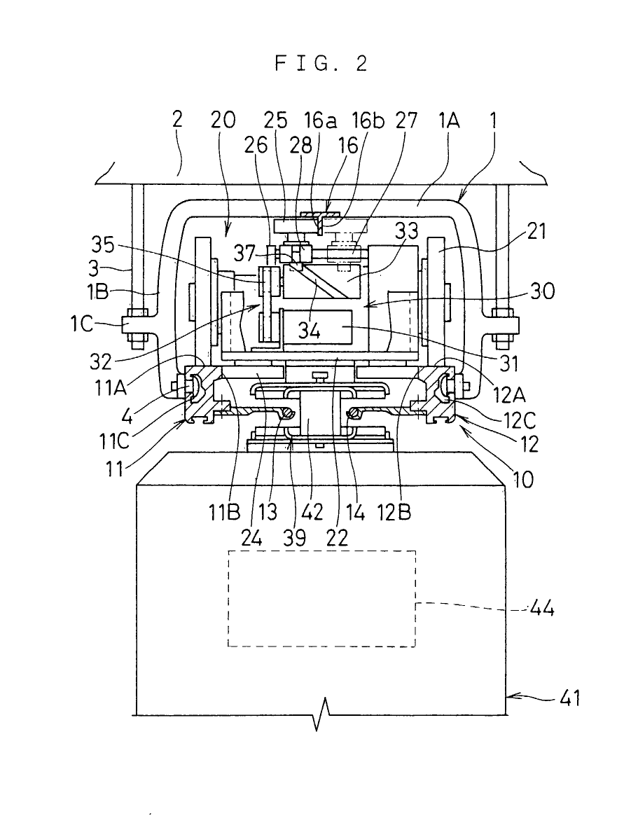

For example, when it is decided that the self-propelled body 20 traveling in the linear path portion 52 travels straight as it is, the direction control roller 25, as shown by phantom lines in FIGS. 2, 4 and 6 (a), is moved to the left. Thereby, the direction control roller 25 is guided by the linear guide portion 16a of the linear guide body 16, and the self-propelled body 20 travels straight as it is, as shown by a phantom line A in FIG. 6(a).

Further, when it is decided that the self-propelled body 20 traveling in the linear path portion 52 branches thereoff to travel to the branching/joining path portion 53, the direction control roller 25, as shown by solid line in FIGS. 1, 2, 4, 5 and 6(a), is moved to the right. Thereby, the direction control roller 25 is guided from the branching/joining guide portion 16b of the linear guide body 16 to the branching guide portion 18b of the branching guide member 18 in the branching/joining guide body 17, and the self-propelled body 20, as shown in FIG. 6(b), branches thereoff to travel to the branching/joining path portion 53.

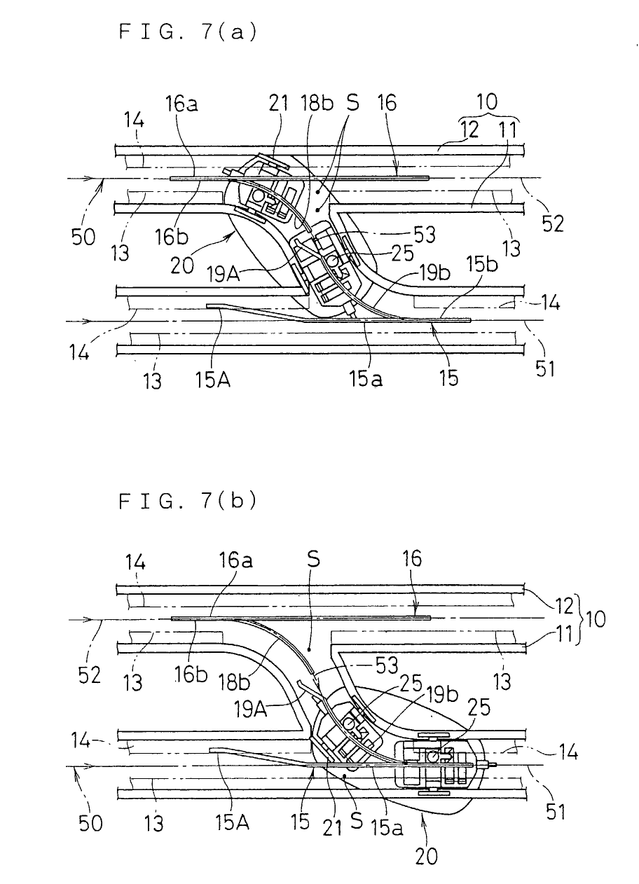

The direction control roller 25 guided by the branching guide portion 18b is engaged by the pickup portion 19A of the joining guide member 19 in the branching/joining guide body 17 and forcibly drawn in and guided. Thereafter, it is guided to the joining guide portion 19b of the joining guide member 19, so that the self-propelled body 20, as shown in FIG. 7(a), travels in the branching/joining path portion 53.

As described above, when the direction control roller 25 is forcibly guided and drawn from the pickup 19A to the joining guide portion 19b, the direction control roller 25 is moved to the left together with the support body 28, so that the guiding is smoothly effected.

That is, although the support body 28 is held (bound) in the right-hand side movement limit position by the attracting action (magnetic force) of the magnetic body 38, the clutch 36 is disengaged at this time, allowing free rotation of the cam roller 33. Therefore, the direction control roller 25 is released from the attraction due to the magnetic body 38 by the drawing force produced as the direction control roller 25 is forcibly guided and drawn in to the joining guide portion 19b, and the cam roller 33 is freely rotated through the cam follower 37 and spiral groove 34. Thus, the direction control roller 25 is automatically moved with the support body 28 to the left.

Subsequently, the direction control roller 25 guided by the joining guide portion 19b is guided to the branching/joining guide portion 15b of the linear guide body 15, so that the self-propelled body 20, as shown in FIG. 7(b), joins in the linear path portion 51 to travel therein.

As shown the in phantom line B in FIG. 6(a), for example, mutual control is effected so that the self-propelled body 20 traveling in the linear path portion 51 which is on the joining side avoids colliding with the self-propelled body 20 coming from the branching/joining path portion 53.

When the self-propelled body 20 moves straight in the linear path portion 51, it will move straight along the linear guide portion 15a of the linear guide body 15 if the direction control roller 25 moves to the right side of the branching/joining place. At this time, since the initial end of the linear guide body 15 has the pickup 15A formed thereon, the self-propelled body 20 will automatically move to the right from the pickup 15A to the linear guide portion 15a, even if the direction control roller 25 has not moved to the right.

When the self-propelled body 20 travels in the linear path portion 52 to branch thereoff to travel to the branching/joining path portion 53, first, as shown in FIG. 6(b), the front left wheel 21 of the self-propelled body 20 is rolled beyond the clearance (missing portion) S between the rail bodies 12 and 12a, and then, as shown in FIG. 7(a), the rear left wheel 21 is rolled beyond the clearance S between the rail bodies 12 and 12a. Therefore, the wheel 21 trying to go over the clearance S falls in the clearance S, and the self weight of the self-propelled body 20 produces moment around the wheel 21 associated with the wheel support surface 11A, tending to tilt the self-propelled body 20.

At this time, however, the direction control roller 25 which is opposed to the wheel 21 positioned in the clearance S and which is in the right-hand side movement limit position is supported and guided by the branching guide portion 18b facing opposite the clearance S, whereby the moment acting on the self-propelled body 20 can be resisted. Thereby, branching travel is smoothly effected while preventing the self-propelled body 20 from tilting, thus, the wheel 21 can go over the clearance S without falling therein.

Further, when the self-propelled body 20 travels in the branching/joining path portion 53 to join the linear path portion 51 to travel therein, first, the front right wheel 21 of the self-propelled body 20 is rolled to go over the clearance S between the rail-bodies 11a and 11, and then, as shown in FIG. 7(b), the rear right wheel 21 is rolled to go over the clearance S between the rail bodies 11a and 11.

At such time, the direction control roller 25 opposed to the wheel 21 placed in the clearance S and located in the left-hand side movement limit position is supported and guided by the joining guide portion 19b facing opposite the clearance s, whereby the moment acting on the self-propelled body 20 can be resisted. Thereby, branching travel is smoothly effected while preventing the self-propelled body 20 from tilting, thus, the wheel 21 can go over the clearance S without falling therein.

Further, when the self-propelled body 20 travels in the linear path portion 51 shown in the phantom line B in FIG. 6 (a) to travel straight in the branching/joining place, first, the front left wheel 21 of the self-propelled body 20 is rolled to go over the clearance S between the rail bodies 12a and 12a, and then the rear left wheel 21 is rolled to go over the clearance S between the rail bodies 12a and 12a.

At such time, the direction control roller 25 opposed to wheel 21 placed in the clearance S and located in the right-hand side movement limit position is supported and guided by the linear guide portion 15a facing opposite the clearance s, whereby the moment acting on the self-propelled body 20 can be resisted. Thereby, straight travel is smoothly effected while preventing the self-propelled body 20 from, tilting, thus, the wheel 21 can go over the clearance S without falling therein.

It is possible for the self-propelled body 20 to smoothly effect, in the manner described above, the straight travel in the linear path portions 51 and 52, the branching travel from the linear path portion 52 to the branching/joining path portion 53, and the joining travel from the branching/joining path portion 53 to the linear path portion 51.

And the feeding of power to the travel drive unit 23 and the like of the self-propelled body 20 is effected by the noncontact power feeding system or the battery power feeding system. That is, the feeding of power in the linear path portions 51 and 52 is effected by the noncontact power feeding system through the pickup coils 39 opposed to the feeder lines 13 and 14 or the like as described above.

At this time, when the self-propelled body 20 is traveling in the linear path portions 51 and 52 and if the feeding of power by the noncontact power feeding system is lacking during acceleration or deceleration, for example, such lack is automatically compensated for by the feeding of power from the battery 44, whereby the intended accelerated/decelerated travel can be smoothly and suitably effected. Further, when the self-propelled body 20 is traveling stably in the linear path portions 51 and 52, an excess of power occurs in the feeding of power by the noncontact power feeding system. At this time, the excess of power in the feeding of power automatically charges the battery 44, thus, the battery 44 can be maintained fully charged at all times.

When the self-propelled body 20 travels in the branching/joining path portion 53, the feeding of power by the noncontact power-feeding system will be cut off since no feeder lines 13 and 14 are laid between the branching place and the joining place thereof. At this time, the feeding of power is automatically switched to that from the battery 44, so that-the travel in the branching/joining path portion 53 can be smoothly effected.

As in the first embodiment described above, constructing the rail device 10 (10a) with a pair of right and left rail bodies 11 (11a) and 12 (12a) makes it possible to define the clearance S over the entire length of the rail device 10 (10a) and the vertically extending through portion provided by this clearance S gives no chance of preventing the flow of air, whereby this system can be suitably employed even if it is used in a clean room where air is blown downward.

FIGS. 9-15 show various embodiments (layouts) of the invention and will be described below in order.

In the first embodiment described above, the self-propelled body 20 in the linear path portion 52 branches thereoff or joins the linear path portion 51 through the branching/joining path portion 53. However, as in a second example shown in FIG. 9, such a layout is also possible that the self-propelled body 20 in the linear path portion 51 branches thereoff or joins the linear path portion 52 through the branching/joining path portion 53.

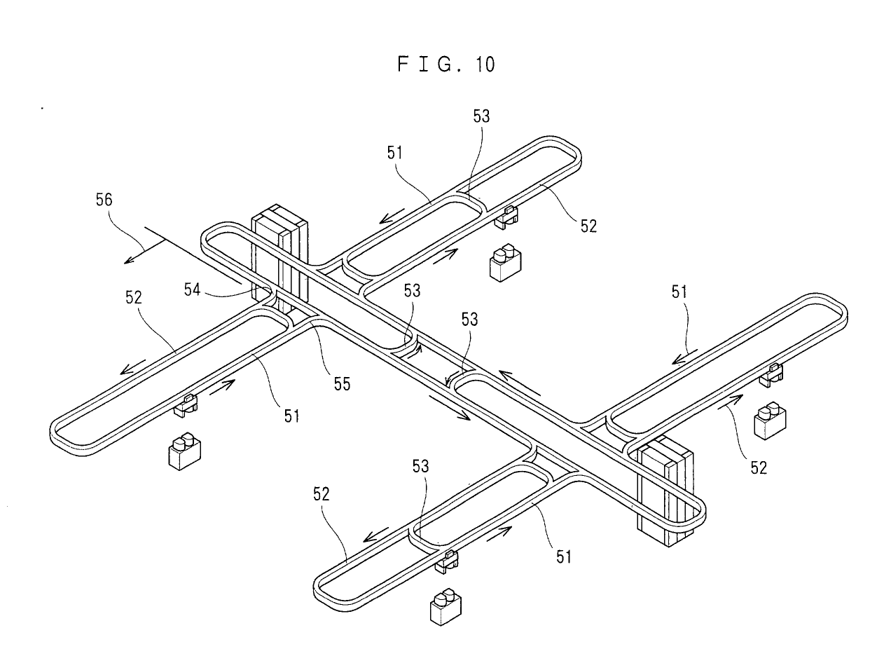

FIG. 10 shows a third embodiment wherein besides the branching/joining path portion (shortcut portion) 53, a branching path portion 54 and a joining path portion 55 are formed in the auxiliary path portions where no feeder lines 13 and 14 are laid. In addition, the junction to an extension line 56 may also be formed in the auxiliary path portion.

FIG. 11 shows a fourth embodiment wherein oval annular path portions 57 form a main path portion in which feeder lines 13 and 14 are laid. The annular path portions 57, formed in a pair, are disposed in a T-shape as seen in a plan view, and a pair (or pairs) of transfer path portions 58 disposed between both annular path portions 57 are formed in auxiliary path portions where no feeder lines 13 and 14 are laid.

FIG. 12 shows a fifth embodiment wherein oval annular path portions 57 form a main path portion in which feeder lines 13 and 14 are laid. The annular path portions 57, formed in a pair, are disposed in a straight line as seen in a plan view, and a pair (or pairs) of transfer path portions 58 disposed between the opposed ends of both annular path portions 57 are formed in auxiliary path portions where feeder line 13 and 14 are not laid.

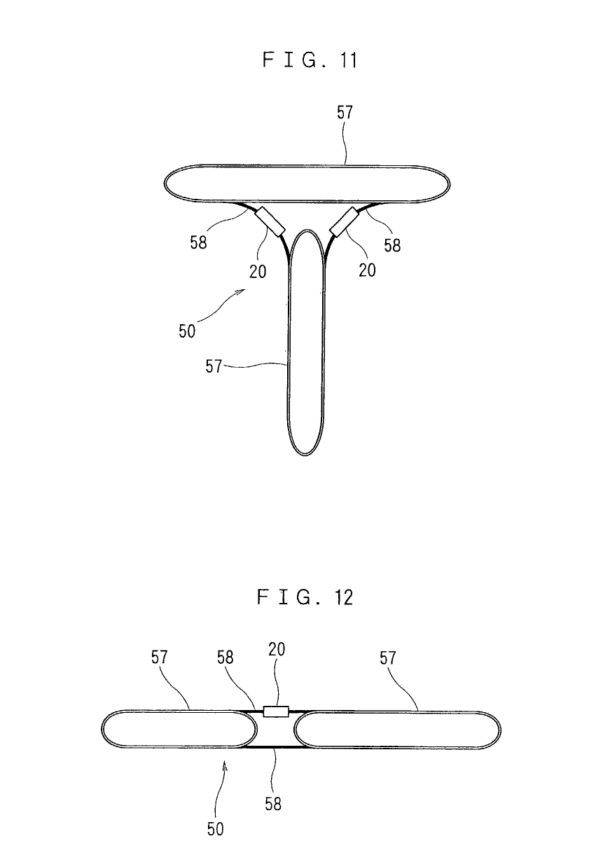

FIG. 13 shows a sixth embodiment wherein an oval annular path portion 57 forms a main path portion where feeder lines 13 and 14 are laid. In this case, a portion of the annular path portion 57 is formed as an outside station path portion 57A provided with a station 59 for loading and unloading transport subjects. And, a pass path portion 60 avoiding the station path portion 57A is formed in an auxiliary path portion where no feeder lines 13 and 14 are laid.

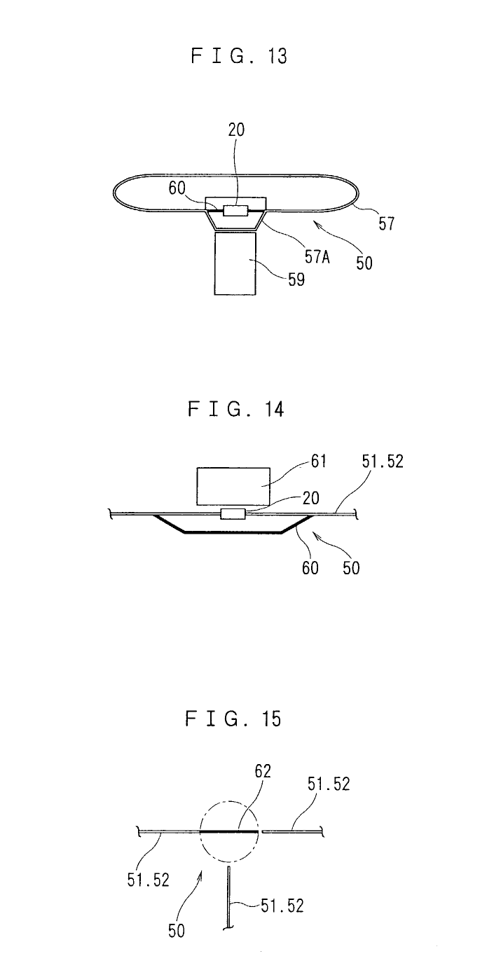

FIG. 14 shows a seventh embodiment wherein linear path portions 51 and 52 form a main path portion where feeder lines 13 and 14 are laid, predetermined portions of the linear path portions 51 and 52 are formed as station, and a stocker 61 is installed outside the station. And, the pass path portion 60 avoiding the station is formed in an auxiliary portion where no feeder lines 13 and 14 are laid.

FIG. 15 shows an eighth embodiment wherein linear path portions 51 and 52 form a main path portion where feeder lines 13 and 14 are laid. The linear path portions 51 and 52 are three in number and arranged in a T-shape as seen in a plan view, and a transfer path portion 62 for a rotary switch is disposed between their opposed ends. The transfer path portion 62 is formed in an auxiliary path potion where no feeder lines 13 and 14 are formed.

In the first embodiment described above, such a type is shown that the holding device 41 is suspended from the self-propelled body 20, however, this may be another type (floor type) in which the holding device is erected on a cart (movable body) traveling on the floor, for example.

In the first embodiment described above, the power storing means is shown as the battery 44, however, this may be a capacitor or the like.

In the first embodiment described above, the holding device 41 is suspended from between the trolley main bodies 22 of the self-propelled body 20 and the transverse transfer means is disposed in the holding device 41, however, it may be another type in which a vertical transfer means is disposed in the holding device 41. Further, other various types may be employed, including one in which a load support block for simply placing an article thereon is mounted, and one in which an article is placed directly.

In the first embodiment described above, guide surfaces are employed as the guide portions 15a, 15b, 16a, and 16b of the linear guide bodies 15 and 16, and as the guide portions 18b and 19b of the guide members 18 and 19 in the branching/joining guide body 17, and the direction control roller 25 is employed as the direction control member. However, the direction control member guided by the guide surface may be in the form of a slidable projection or the like. Further, a combination of a rack used as the guide surface and a direction control pinion used as the direction control roller 25 may be employed.

In the first embodiment described above, the direction control roller 25 is moved right and left through the left- and-right movement device 30 on the basis of the fact that the detector 40 detects the detection subject and makes a decision, however, another type may be employed in which the position of the direction control roller 25 is brought back (reset) to the original state on the basis of the fact that the detector 40 detects the detection subject after having passed through the branching/joining place.

What is claimed is:

1. A conveyance system comprising a rail device, and a movable body supported and guided by the rail device to move in a fixed path, characterized in that
a main path portion of the fixed path includes a feeder line laid along the main path portion, and a power receiving means opposed to the feeder line is installed in the movable body, whereby the feeding of power to the movable body is effected by a noncontact power feeding system, while in an auxiliary path portion having no feeder line laid therealong in the fixed path, the feeding of power is effected by a power storing means mounted on the movable body.

2. A conveyance system as set forth in claim 1, characterized in that the auxiliary path portion is a path portion which branches off or joins the main path portion.

3. A conveyance system as set forth in claim 1, characterized in that when the feeding of power by the noncontact power feeding system becomes insufficient during travel in the main path portion, the insufficiency is compensated for by the feeding of power from the power storing means.

4. A conveyance system as set forth in claim 1, characterized in that during travel in the main path portion, the power storing means is charged with power by an excess of power provided by the noncontact power feeding system.
